(19) United States
(12) Patent Application Publication
(10) Pub. No.: US 2010/0181511 A1
(43) Pub. Date: Jul. 22, 2010

(54) ACTUATOR FOR A PILOT FOR HYDRAULIC CONTROL VALVES

(76) Inventor: Egil Eriksen, Foldroyhamn (NO)

Correspondence Address: PATTERSON & SHERIDAN, L.L.P., 3040 POST OAK BOULEVARD, SUITE 1500, HOUSTON, TX, 77056, US

(21) Appl. No.: 12/664,044

(22) PCT Filed: Jun. 16, 2008
(86) PCT No.: PCT/NO2008/000217

§ 371 Date: Dec. 10, 2009

(30) Foreign Application Priority Data
Jul. 4, 2007 (NO) 20073463

(51) Int. Cl. F16K 31/02

(52) U.S. Cl. 251/129.03

(57) ABSTRACT

An actuator for a pilot for a hydraulic control valve including a direct-current servo-motor (1) provided with a high-ratio gear (4) and arranged to be operated by a battery (2) with an associated battery charger (13), and an oil return port (10), a pilot port (11) and a hydraulic supply (12) and via the gear (4), the servo-motor (1) is arranged to move a valve stem (5) which bears via a first valve ball (7) on a spring-loaded pilot needle (8) which bears, opposite the first valve ball (7), on a second spring-loaded valve ball (7), a spring and a return spring (9) being arranged to move the valve balls (7) towards the pilot needle (8), and a microprocessor with an associated controller (3) being arranged to determine the position of the valve stem (5) by registration of the rotational position of the servo-motor; and, if a control signal is interrupted, the controller (3) is arranged to drive the valve stem (5) into a predetermined position by means of current from the battery (2).

The invention relates to an actuator for a pilot for hydraulic control valves, as indicated in the preamble of the accompanying claim 1.

The power consumption is the main problem with today's valve pilots operated by a solenoid. The iron core of the magnet carries out a linear movement when the coil is energized, and a spring resets the core to its initial position. To avoid having a constant current on coils, for reasons of power consumption and temperature, it is common to make use of low-energy solenoids and pulse operation of control valves with hydraulic hold function, so-called hydraulic latch.

This has several drawbacks:
In some cases a coil will be a problem because of high power consumption. Coils that have low power consumption, typically 0.125 A, 3 W at 24 DC, have a high failure rate. A current coil is a simple on/off element and lacks several of the functions which the invention of the application has.
It is common to take hydraulic pilot operation pressure from the hydraulic supply of the control valve. The hydraulic hold function may be unstable, so that if the input pressure is adjusted too low, or if the pressure falls below a critical level in valve operations, the hold function could fail, which may have undesired consequences.
Operation with a current coil may give undesired pressure surges because of instantaneous operation and lack of dampening.
The valve is bound to a particular failure function, fail safe or “as is”.

From the literature is cited as background art:

EHPC actuators for steam turbines; http//www.woodward.com/pdf/ic/85189.pdf

PGPL actuators for steam turbines; http//www.woodward.com/pdf/ic/37520.pdf

The two publications cited describe commercial shelf items with actuators in which the pilot draws only a few milliamperes, and in which the actuator has a direct-current electromotor.

The comparison with the present invention is not relevant as the present invention differs substantially from them through different application and functionality, which are characterized by:
The application of the present invention being a pilot typically intended for controlling a control valve in an underwater control module for the operation of underwater production equipment or tools, in which the requirement for monitoring and emergency shut-off is high.
Woodward's typically being used for controlling the main step in a process valve for the control of fuel supply and, through this, the control of admission/rotation of a diesel engine/turbine.
It being important to note that the invention relates to a pilot function and not the main step of a hydraulic valve. The invention is to provide an intelligent control function for a hydraulic pilot for the operation of an underwater hydraulic valve or a valve at the surface.

The invention has for its object to remedy or reduce at least one of the drawbacks of the prior art.

The object is achieved through features which are specified in the description below and in the claims that follow.

The present application relates to an actuator for a pilot for hydraulic control valves, and the actuator is characterized by the characteristics submitted in claims.

In what follows, there is described an example of a preferred embodiment which is visualized in the accompanying single figure, in which:

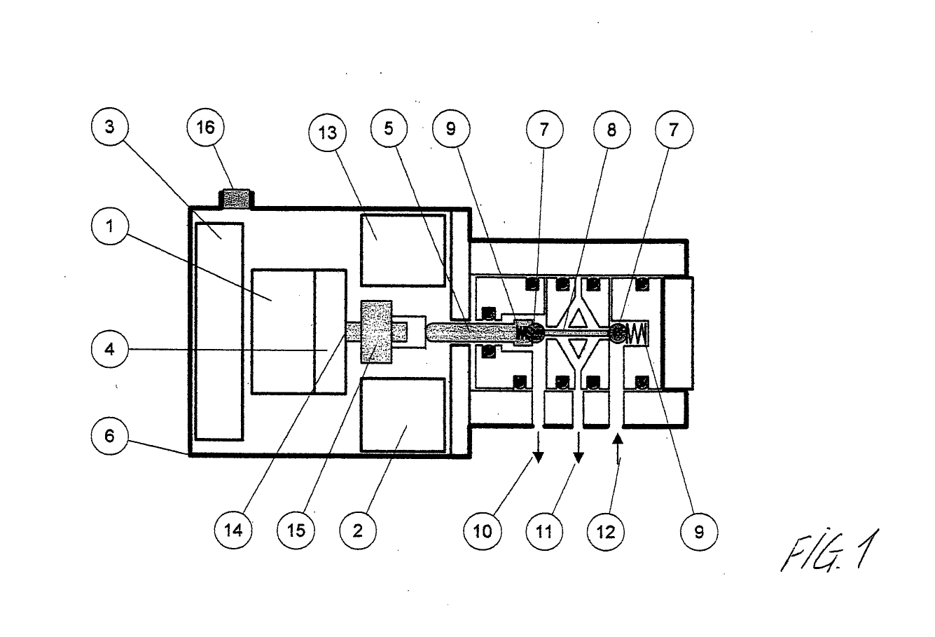

FIG. 1 shows a longitudinal section through a device according to the invention, in which the reference numeral 1 indicates a direct-current servo-motor 1 connected to a battery 2 and also a controller 3 in a microprocessor, and is provided with a gear 4. A valve stem 5 is connected to the gear 4 and arranged in a valve housing 6. Two valve balls 7 bear on a pilot needle 8 by means of a spring/return spring 9, and the valve housing 6 is provided with an oil return port 10, a pilot port 11 and a hydraulic supply 12.

Further, the valve housing 6 accommodates a battery charger 13, and a threaded mandrel 14 with a threaded-mandrel nut 15 is arranged between the gear 4 and the valve stem 5. The valve housing is provided with a bushing 16 for a wire.

The servo-motor 1 fitted with the high-ratio gear 4 drives the valve stem 5 which bears on the spring-loaded pilot needle 8.

The position of the valve stem 5 is determined by a microprocessor which is mounted on a board in the controller 3, reading the position of the servo-motor 1. If the control signal is lost, the controller 3 may drive the valve stem 5 into the desired position by means of current from the battery 2.

The rotating motion is converted into a linear movement by means of the threaded mandrel 14 and the threaded-mandrel nut 15 activating the pilot needle 8.

By replacing a prior art solenoid-operated pilot actuator with a pilot operated by an actuator according to the invention, advantages are achieved with a view to power consumption, control and reliable operation:
The valve position is ensured independently of the operational pressure.
Control of the opening/closing characteristics of the valve prevents hydraulic pressure surges.
The system flexibility is increased through the possibility of reprogramming the failure position of the valve.
Active monitoring of the position of the valve.
The hydraulic hold function is replaced.
The pilot may be used to make a cartridge valve fulfil requirements of control valves that are used in the oil industry, such as fail safe function or “as-is” function while the valve is in use.
By means of motor data, diagnostics of the pilot are carried out by feed-back being given on the position of the stem 5.
Increased flexibility with programming of the function of the valve will provide a gain through standardized purchase of valves and when purchasing spare parts.
There is full control of the operation time.
Sufficient momentum is available for reliable function to be achieved, and the position of the valve is secured without the drawbacks experienced with a hydraulic hold function (“latch”).
The pilot draws only a few milliamperes of current when activated.
There is feed-back on position and diagnostics of the pilot may be established via motor data. In some cases this may permit for leaving out pressure transmitters at the output of the valve for feedback, which may be desirable on account of space and cost.
The battery 2 provides for the servo-motor 1 to go to the desired position if the signal is lost. The battery 2 is charged by the battery charger 13 during normal operation.
Reprogramming of the fail safe function or “as-is” function of the valve is possible while the valve is in operation, and a different function may be had when the control system operates in a new mode of operation, if desirable.
The microprocessor 3 of the pilot controls the servo-motor 1 with a positioner. There is a pulse-counter in the servo-motor 1 which can provide high resolution of pulses per revolution and great accuracy in the operation of the pilot. This provides the possibility of configuring and changing the opening and closing characteristics of the valve.

Valves of today, which are used for these applications, use coils and have a plain on/off function. By high operational pressure, critical pulse surges in the hydraulic system can be dampened through the control of the opening characteristics of the pilot according to the invention.
The function permits for an electric hold function as a supplement to the hydraulic hold function. Today, with electric hold function, the power consumption is high, as the coil stays at full power. This is avoided with the invention of the application, and both temperature and power consumption are reduced.
The microprocessor 3 makes it possible to reprogram the functions via communication from the surface. A typical change is from normally closed to normally open or “fail as is”.
The control system is to have feed-back/continuous monitoring from the surface, which is important but is not achieved with the prior art. This draws a few milliamperes to keep the circuit active.
With the battery 2 and battery charger 13 in the pilot, valves can be emergency-operated several times if the power supply from the surface is interrupted.
If the main communication is interrupted, the valve is to be able to go automatically to a predetermined position.
The invention permits for the use of cartridge valves in an underwater control module application. Cartridge valves are favourable in size in relation to mounting into a manifold, but today's pilots for cartridge valves do not fulfil the “fail safe” requirement. The physical size of a valve manifold can be reduced to about one third of the dimension of today. Advantages of this are reduced weight and that a more compact design is achieved for different underwater applications.

1. An actuator for a pilot for a hydraulic control valve including a direct-current servo-motor provided with a high-ratio gear and arranged to be operated by a battery with an associated battery charger, and an oil return port, a pilot port and a hydraulic supply, characterized in that
via the gear, the servo-motor is arranged to move a valve stem which bears via a first valve ball on a spring-loaded pilot needle which bears, opposite the first valve ball, on a second spring-loaded valve ball, a spring and a return spring being arranged to move the valve balls towards the pilot needle, and a microprocessor with an associated controller being arranged to determine the position of the valve stem by registration of the rotational position of the servo-motor; and,
if a control signal is interrupted, the controller is arranged to drive the valve stem into a predetermined position by means of current from the battery.

2. The actuator according to claim 1, characterized in that the rotating motion of the servo-motor rotates a threaded mandrel relative to a threaded-mandrel nut, whose rotation generates a linear movement of the pilot needle.

3. The actuator according to claim 1, characterized in that with motor data, diagnostics of the pilot are given on the basis of the registration of the position of the valve stem.

4. The actuator according to claim 1, characterized in the rotational speed of the servo-motor is adjustable.
